(19) United States
(12) Patent Application Publication
(10) Pub. No.: US 2006/0284002 A1
(43) Pub. Date: Dec. 21, 2006

(54) Unmanned Urban Aerial Vehicle

(75) Inventors: Kurt M Stephens, New Port Richey, FL (US); David W Burns, Lake Mary, FL (US)

Correspondence Address: Mr.David W Burns, 2523 Fletch Ct, Lake Mary, FL, 32746, US

(73) Assignees: Kurt M Stephens, New Port Richey, FL (US); David W Burns, Lake Mary, FL (US)

(21) Appl. No.: 11/307,461

(22) Filed: Feb. 8, 2006

Related U.S. Application Data
(60) Provisional application No. 60/593,712, filed on Feb. 8, 2005.

(51) Int. Cl. B64C 29/00

(52) U.S. Cl. 244/12.4; 244/56

(57) ABSTRACT

The proposed UUAV provides a small, agile vehicle that leverages the unique principals of remote controlled model aviation. The UUAV also encompasses an aerodynamically shaped, gas filled wing that can be used to provide buoyancy for lift assistance both through the use of the lighter than air gas and by its aerodynamic shape in forward flight.

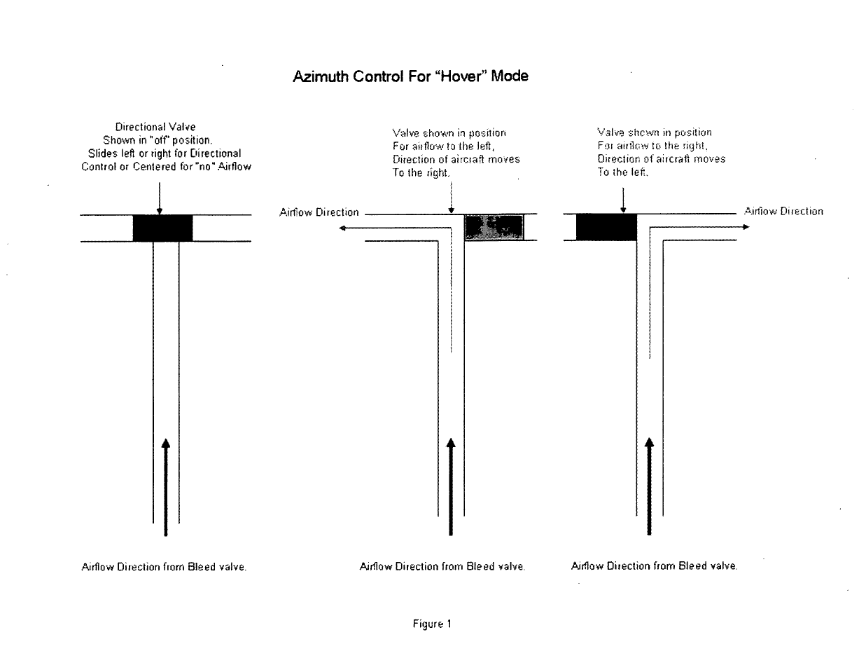

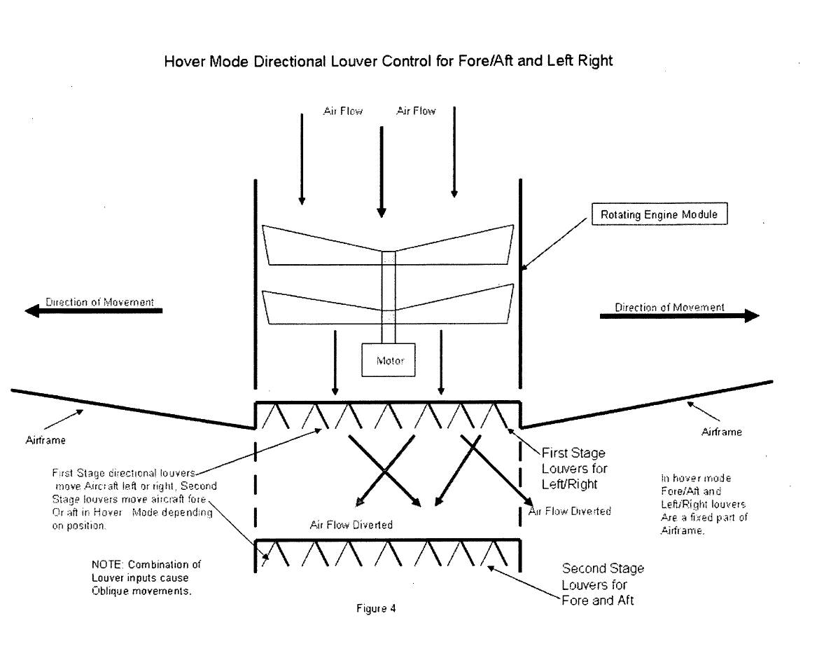

This paper describes an innovative design for an Urban Unmanned Aerial Vehicle (UUAV). This design is based on the unique principals of remote controlled model aviation enabling the inexpensive design and manufacture of a small, highly maneuverable aircraft. The design uses a pseudo donut shaped, reinforced, gas bag wing filled with lighter than air gas to provide lift assistance for the vehicle and sensor payload. This wing will be contained within a lightweight carbon fiber exoskeleton to provide structural integrity and payload mounting capability. The design uses a dual counter rotating ducted fan propulsion system for increased vertical lift and elimination of airframe torque. The lift motor and counter rotating rotors will be mounted mid level within the center of the donut hole to provide the necessary lift forces and motor cooling to increase efficiency, substantially reduce noise levels, and lower power consumption. The use of louvered trim tabs at the exhaust end of the engine module will be used for stabilization control in the hover mode(FIG. 4). In a hover mode directional or azimuth control will be obtained by the use of bleed air from the thrust engine through tubing that terminates in a “T” at the outer edge of the airframe that is controlled with the rudder stick which positions a piston either in a complete airflow blockage or moves from one side to the other to allow thrust in either direction that is metered to rotate the airframe(FIG. 1). In forward flight this function will be disabled since the engine will have been rotated to the horizontal position and minimal airflow into this system will occur. The thrust tube will be mounted below the forward flight control louvers located at the aft thrust exhaust exit in a fashion that enables rapid change in direction through 360 degrees providing a high degree of maneuverability and agility in the hover mode of operation. Directional controls in both forward and hover flight modes will be operating at the same time for simplicity and cost effectiveness purposes yet will not interfere with each other due to the movement of the engine module and cutoff of airflow to the nonfunctional or unused control louvers. In the forward flight regime or mode of operation the engine module will rotate slowly aft and build up airspeed and airflow over the aerodynamic shape of the airframe. As forward airspeed begins to afford translational lift from the airframe shape the engine module will be rotated into the horizontal thrust configuration using the airflow intake located at the forward nose of the aircraft and the exhaust tube for exit of airflow through the directional and elevation louvers for aircraft control while shutting off airflow from the top of the intake tube. In this regime the craft will fly like a fixed wing aircraft.

Introduction—Many of the Unmanned Aerial Vehicles (UAV) available today are configured in the fashion of an airplane or helicopter. These UAVs are generally heavy, loud and large which limits their effectiveness in urban environments. Ducted fan technology like that used in the Organic Air Vehicle (OAG) has been demonstrated for vertical take-off/hoverable UAV application but again the size is large and limits their use in urban environments. The sound generated by these vehicles is significant, thereby reducing stealth capability. Additionally, these units cannot be shut down and restarted like electric powered craft. In the case of the UUAV design both flight regimes are achieved, both hover and forward flight. Use of light materials, an exoskeleton and lighter than air bag used as an airfoil provides lift and additional payload capability while reducing the amount of power required thus increasing the endurance of the vehicle. Although the use of a lighter than air bag does not provide a huge benefit in capability and endurance the reduction of weight. In forming the physical structure does make a significant difference when combined with the lighter than air effects. Noise reduction will be further enhanced by placing the engine module within the aircraft structure and direct sound either vertically up and down significantly reducing the detection in an horizontal or azimuth plane or fore and aft reducing sound in a vertical plane where detection of ground personnel would be enhanced. In this case the eye ball in an eye socket design would effectively close off sound vertically. The proposed UUAV provides a small, agile vehicle that leverages the unique principals of remote controlled model aviation. The UUAV also encompasses an aerodynamically shaped, gas filled wing that can be used to provide buoyancy for lift assistance both through the use of the lighter than air gas and by its aerodynamic shape in forward flight.

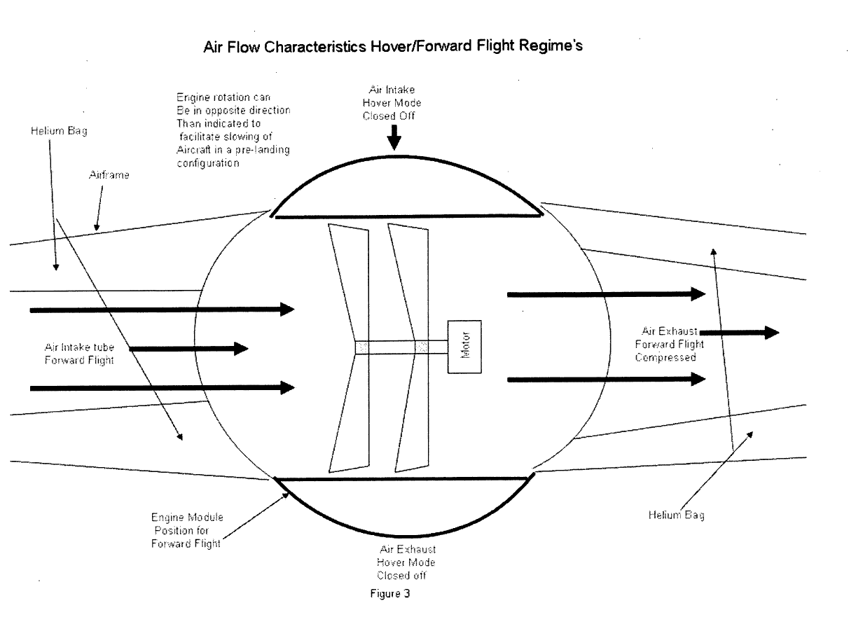

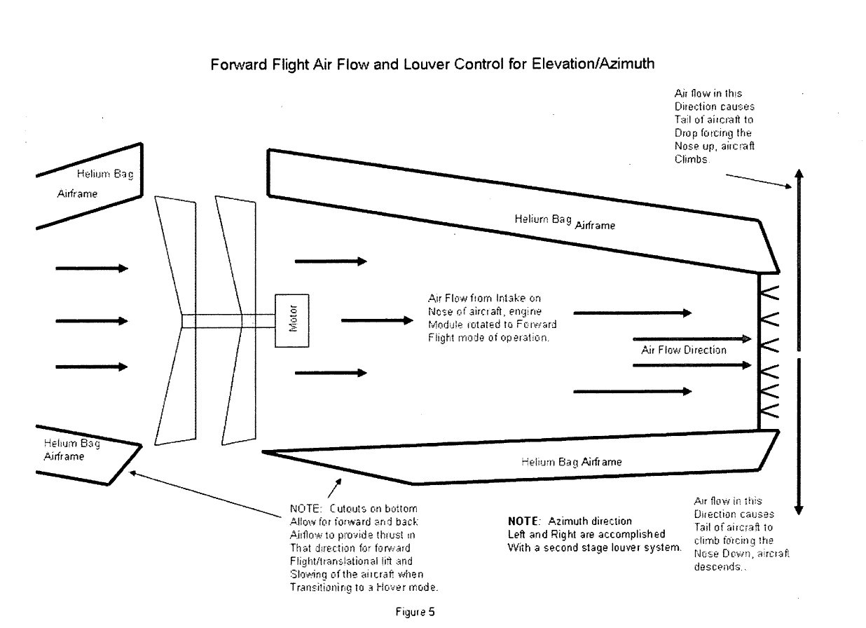

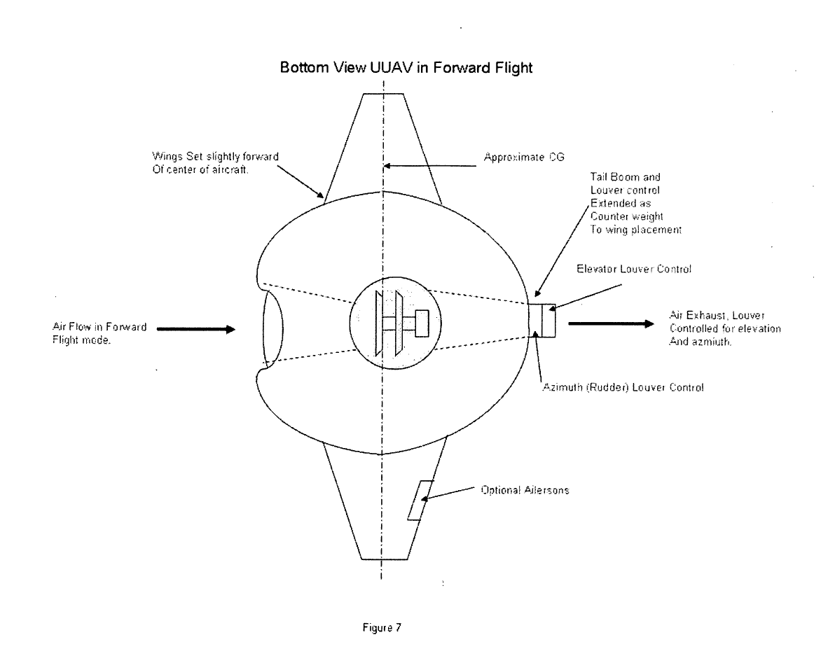

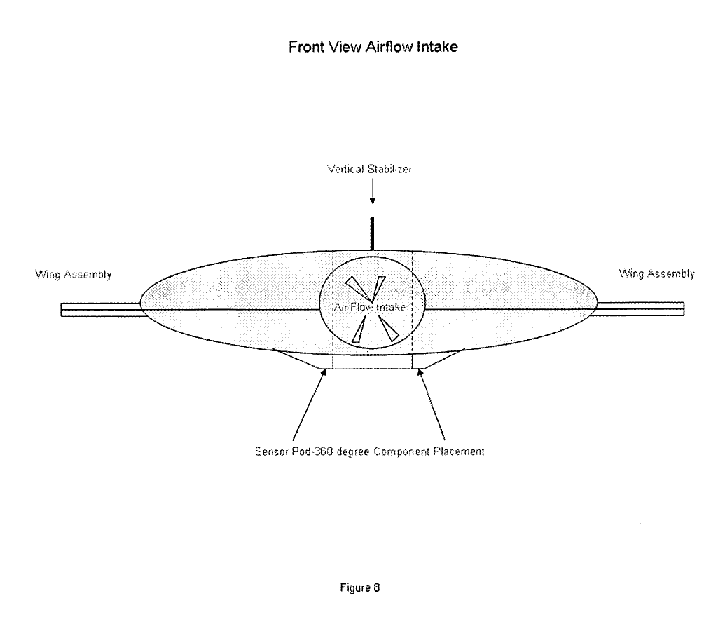

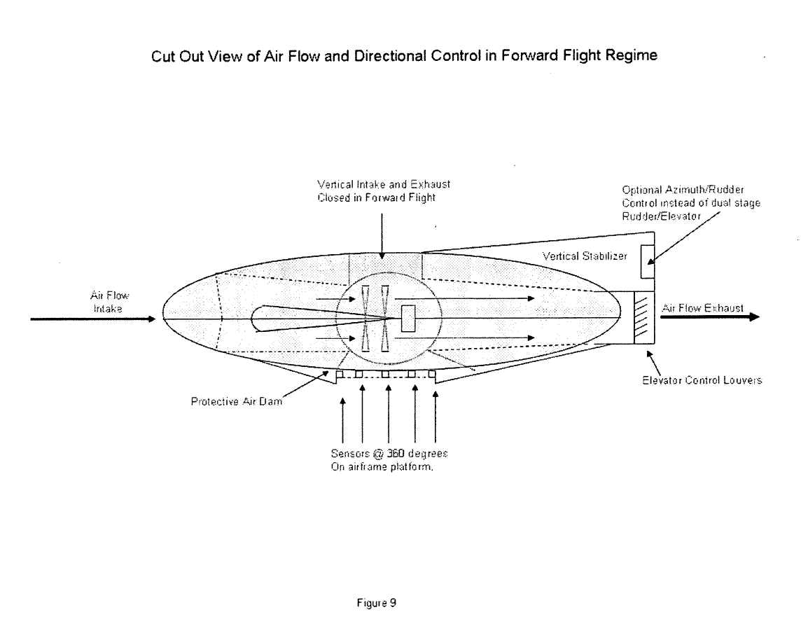

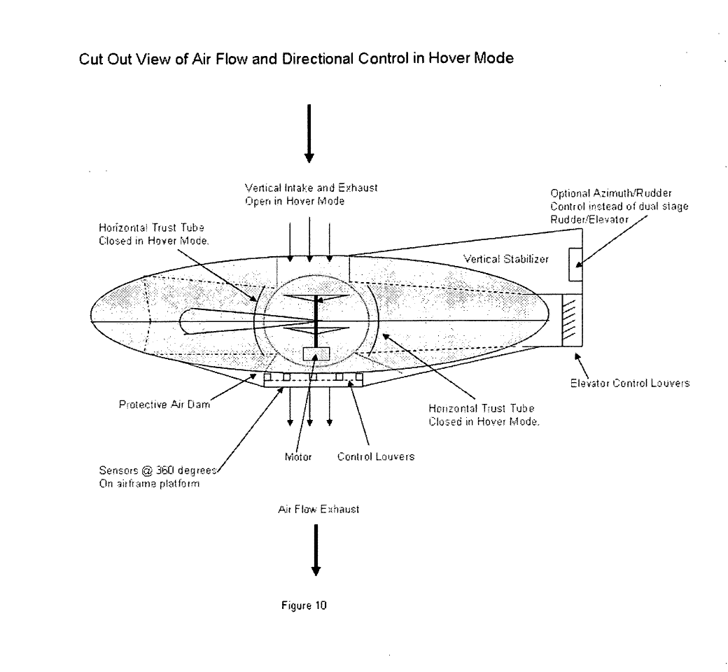

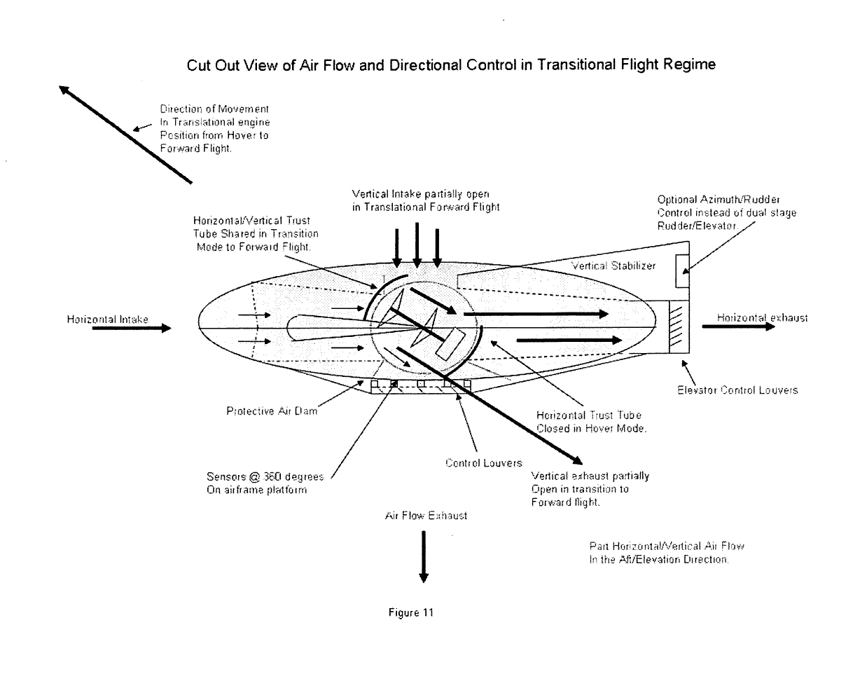

Structural Design—The proposed UUAV design is unique in it's configuration from current UAV technology. FIGS. 1 through 11 shows the structural configuration of the UUAV.

The body is constructed of a pseudo-donut shaped gas filled wing shrouded with a lightweight exoskeleton. The gas filled balloon will be made of a strong, lightweight material like Mylar™. It provides the vehicles aerodynamic shape and can be filled with a lightweight gas like helium to provide “lift assist” in order to increase payload and/or range capability. At minimum payload, the vehicle will be capable of hover or flight by simply filling the wing with air and minimal power applied. Lightweight gasses will enable increased payload capacity and/or range capability while still forming the aircraft aerodynamic shape for lift in flight.

The exoskeleton will be constructed of lightweight material like aluminum, magnesium, carbon fiber composite, or a combination of these materials capable of providing structural integrity to support the centrally mounted ducted fan, azimuth thrust vectoring, flying wing/ailerons and camera/counterweight.

The gondola platform extending below the main body lowers the center of gravity to ensure stable horizontal flight as well as providing a mounting platform for additional sensors. The UUAV's center of gravity will play a critical role in horizontal and vertical stabilized flight as the thrust propulsion must be generated in plane with the center of gravity to minimize torque causing the aircraft to pitch and yaw during acceleration.

Propulsion Mechanisms—For vertical take-off and hovering capability, the UUAV utilizes a ducted fan propulsion system. The system consists of an electric motor with counter-rotating blades mounted in the center hole of the gas filled wing. The counter rotating blades are primarily designed to eliminate torque but also provide additional vertical/horizontal thrust.

The thrust motor will be mounted in an eye ball-eye socket vertical stack that in a hover mode will take airflow in the vertical direction (top to bottom) of the fixed stack using directional control louvers at the exhaust end for stabilization control. In the forward flight regime the engine module will rotate aft to the horizontal utilizing the fore and aft intake/exhaust tube for airflow and directional louvers located at the exhaust. In the hover mode a bleed air system will provide azimuth control changes. The fixed or gimbaled camera system that is used will be forward mounted to offset the weight difference of the control louvers used in the forward flight regime. This weight can be augmented with a fixed camera system mounted on both top and bottom airframe and include a down looking camera as well if required to serve as a counter weight. Small flying wings with ailerons will be mounted on the flanks to provide additional lift and roll if required during forward flight.

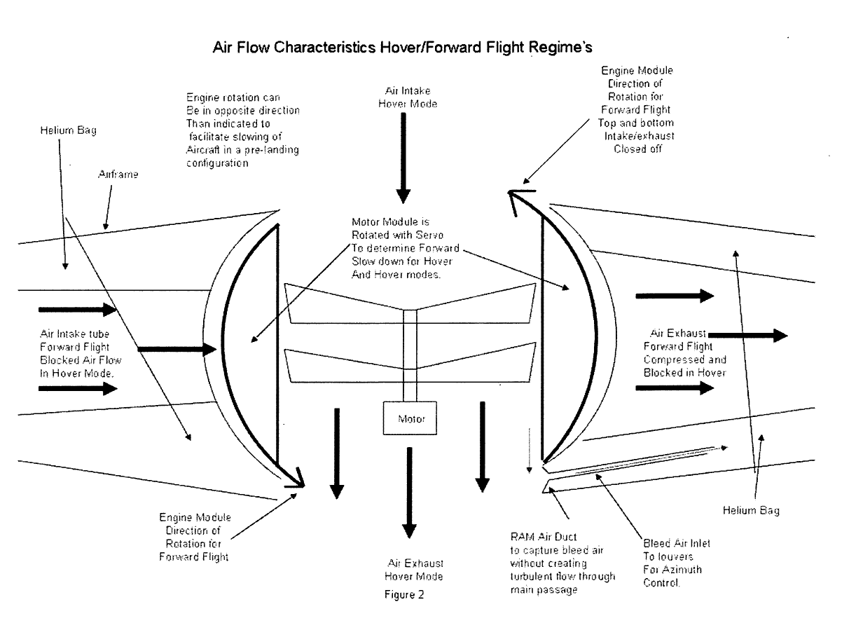

An alternative configuration entails use of a rotating band around the perimeter of the vehicle with a fixed empennage. In this configuration, the horizontal thrust tube via bleed air, camera and ailerons will be fixed in position relative to each other (90 degrees apart) and will be capable of rotating 360 degrees around the perimeter of the vehicle using a servo motor. This configuration maintains proper weight distribution while providing vehicle agility and maneuverability. FIG. 2 shows the top down configuration depicting the orientation of the thrust motor, camera/counterweight and flying wings/ailerons.

The servo motor provides a lightweight, low power mechanism for rotating the horizontal flight and camera system through 360 degrees. This feature provides the UUAVs increased agility by enabling rapid redirection of thrust propulsion. The UUAV will be able to stop quickly and return to hover or it can change course by 180 degrees nearly instantaneously. The rudder mounted with the thrust motor in conjunction with the flying wings/ailerons provides steerage control while the vehicle is in flight and the elevator control will assist in vertical flight lessoning the power requirements of the vertical thrust motor and counter rotating blades.

Benefits of Urban Unmanned Aerial Vehicle Design—U.S. forces in Iraq and other theatres increasingly rely on UAVs to perform dull (sentry), dirty (biochemical and unexploded ordnance analysis) and dangerous (recon in close proximity to enemy forces) duties [1]. U.S Military troops and commanders need a surveillance capability that will loiter over a target for sufficient time to monitor movement by the target in an urban environment. The ability to send such an expendable, yet recoverable device into a possibly hostile environment before committing military personnel will greatly enhance the safety and well being of our troops. Preference would be given to a vehicle that would capture day or night imagery, while being able to navigate narrow streets and buildings. Additionally, the UUAV may be tasked with “mine” detection with the addition of metal detection electronics and low flight capability. The evolution of our armed forces indicates that such a vehicle will be required as much or more in the future as now.

The UUAV can be used for such varied missions as extended guard duty while tethered to a ground based or mobile energy source, tactical reconnaissance in broad and denied areas, battle management, or as an aid in targeting with precision munitions. It will conduct numerous force protection missions for both moving and encamped outfits.

The UUAV will be especially advantageous for urban surveillance and reconnaissance, extended sentry duty, and fly along missions with moving convoys. Recent events in Iraq point out the immediate need for improved force protection and other sentry duties that can best be performed by a hovering UAV, particularly one that can conduct extended operations, alerting security personnel to any incursions along a perimeter

Design Variation—Tethered Surveillance Configuration

In addition to the remote controlled configuration, this design can also be configured for tethered operations. The Tethered Surveillance Configuration will allow for surveillance of the area with day video and night IR (Infra Red) surveillance of the surrounding features to enhance situational awareness. The unit will be tethered with video feed, audio, and sensor feeds via stationary power sources which can be solar, shore power, or wind power. This can be accomplished via normal civilian power sources or NATO Plug rejuvenation via government vehicle. The configuration provides the ability to monitor the surrounding area with video feed day/night for protection and early detection of hostile/friendly forces. The device will encompass the ability to hover continuously for days using zero buoyancy superior aeronautical engineering and electrical power which will be silent and economical in nature. Replenishment will be at minimum cost to the government. Cost to develop and deploy such a device will also be minimal. Mass manufacturing will also be cost effective and available with current manufacturing capabilities.

Sensor deployment will be encouraged and development will compensate for the weight to power relationships. Sensors under consideration will be day/night video, early detection of enemy forces, radiation, chemical, and biological agents, and alarms to facilitate the early warning capability. Deployment of such a device will inhibit many of the past and current disasters that have occurred by increasing situational awareness and readiness. Currently, the use of weapons for defense is not being considered for such a device, due to the proximity of the device to friendly forces. However, forward or perimeter deployment may facilitate such activity where friendly forces are not susceptible to the force rendered. Such a device will require a data reception center that can monitor the available sensor inputs and detect other than obvious alarms. HUMIT will play a factor in this concept.

Fly Along UUAV Configuration

Military convoy attacks are prevalent in the Middle East. This concept will provide added protection to these convoys. A tethered surveillance vehicle will fly in formation with its guard vehicle and provide the needed video day/night surveillance information that a convoy needs to accomplish its mission safely. This aerial vehicle being tethered (attached by wire), will fly in formation with the feed vehicle and provide the required data which will allow the formation to see well in advance, any enemy forces on the prowl, wishing to cause harm to our forces. This device will fly in formation and provide the data via a tether that will provide auto pilot function to keep pace with the lead vehicle in roll, pitch, and yaw. Essentially the airborne vehicle will follow every movement of the vehicle in command. In situations where overpasses or low clearance areas are encountered the vehicle may be reeled in or flown at a lower altitude to prevent damage or loss. Since the power will be supplied from the electrical capability of the vehicle, duration of flight will not be an issue. An operator in the vehicle will monitor the data activity as the convoy proceeds along its assigned path. Early warning in this area of operations is essential to the safe and secure transportation of the personnel, goods and weapons in transit.

### REFERENCES

1. OSD UAV Roadmap, Office of the Secretary of Defense (Acquisiton, Technology and Logistics), Air Warfare.

What is claimed is:

1. This application describes a unique Urban Unmanned Aerial Vehicle design that combines hover capability with forward flight characteristics by the use of thrust vectoring obtained from a counter rotating dual blade engine system that is modular in design and rotates within the body of the airframe providing thrust in the vertical as well as the horizontal plane eliminating the disruptive airflow problems associated with forward flight using a vertically mounted engine system with vertical intake and exhaust when transitioning into forward flight mode. This is accomplished by using the modular system in an eye ball, eye socket configuration which closes off the vertical airflow at the intake when in a hover to prevent airflow disruption. As the engine eye ball configuration is rotated to the horizontal (fore and aft) position the upper and lower airflow intakes are effectively closed off and replaced by airflow intake and exhaust in the horizontal direction through intake and exhaust tubes designed to accelerate airflow further. FIGS. 2 through 11 depict the central propulsion system in the various modes of flight.

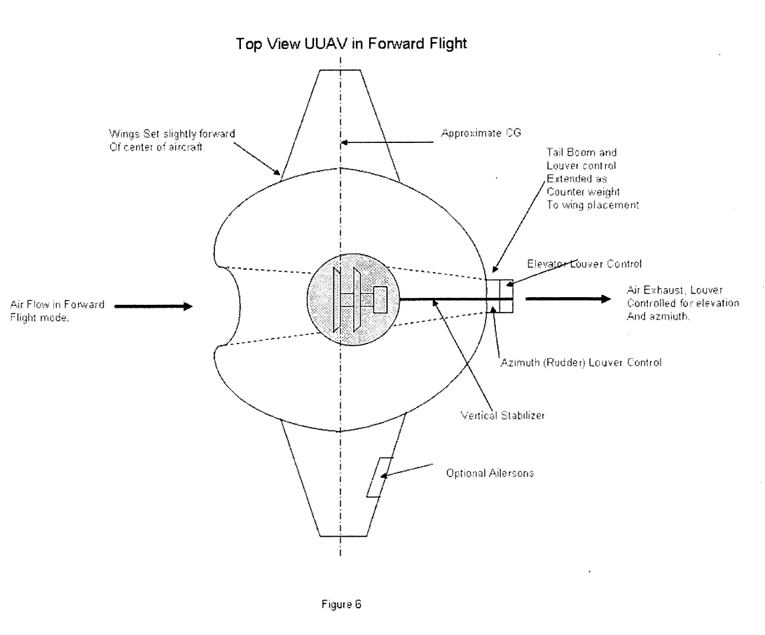

2. To accomplish pitch, roll and yaw movement in hover or forward flight modes, the design uses two gang control louver systems. Details are provided in 4 and 5. In forward flight, the design can also use a single louver for pitch (elevation) control with standard rudder and aileron controls for roll and yaw. Details are provided in FIGS. 6, 7, 10 and 11.

3. Directional or azimuth control in Hover Mode will be accomplished through use of a RAM Air Duct feed to a bleed air tube from the thrust engine that terminates in a “T” at the outer edge of the airframe. Control will use a rudder stick that positions a piston either in a complete airflow blockage or moves from one side to another to allow thrust in either direction that is metered to rotate the airframe. Detail is depicted in FIG. 1

4. The Urban Unmanned Aerial Vehicle described by claims 1, 2 and 3 can be used in multiple configurations to accommodate a variety of in flight functions including tethered and fly along applications.
